(19) United States
(12) Patent Application Publication
(10) Pub. No.: US 2014/0051403 A1
(43) Pub. Date: Feb. 20, 2014

(54) APPLICATION FOR A MOBILE PHONE

(71) Applicant: Klaus Christensen, Copenhagen (DK)

(72) Inventor: Klaus Christensen, Copenhagen (DK)

(21) Appl. No.: 13/585,174

(22) Filed: Aug. 14, 2012

(51) Int. Cl. H04W 4/12

(52) U.S. Cl. 455/414.1

(57) ABSTRACT

An application provides a SMS program module in a mobile computing device, e.g., telephone, with an Auto reply function, which can send response messages in case the telephone is switched off or in flight mode or if the user is not available. A method includes a text secretary and a library which are created and connect the SMS program module with the calendar in the telephone and with a contact database.

### BACKGROUND

1. Field of Endeavor

The present invention relates to an application for storage in a memory of a mobile phone.

2. Brief Description of the Related Art

The use of smart phones is widespread and today smart phones are used in all parts of the world. A smart phone is basically a small handheld computer which also functions as a telephone. Due to the fact that a smart phone is a computer, it is able to run computer programs. When such computer programs are designed for use on a smart phone they are normally known as applications or shortly as “Apps”.

Many Apps relate to games which can be played on the smart phone; however, more practical apps have also been developed such as apps that allow the user to manage bank business from the smart phone, checking flight and train timetables, etc.

The market for Apps is increasing and new Apps are released on the market every day.

Although a high number of Apps are available for users of smart phones it has been realized that no Apps have been concerned with the SMS, short message service, which is a standard on all cell phones including smart phones.

### SUMMARY

One of numerous aspects of the present invention includes an improvement to the short message service on smart phones.

Consequently, another aspect of the present invention includes an application for storage in a memory of a mobile phone comprising: creation of a text secretary in the SMS program module, which text secretary creates a library connected with the SMS program module and optionally a calendar program, which library comprises one or more text messages (SMS).

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a diagram of how, according to principles of the invention, a Text secretary and a Library interact with an SMS Menu and a Calendar in a mobile telephone; and

FIG. 2 illustrates a highly schematic, top plan view of an exemplary mobile telephone handset including a user interface, including access to a text secretary.

### DETAILED DESCRIPTION OF EXEMPLARY EMBODIMENTS

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the systems described herein are merely exemplary applications for the invention.

It should be appreciated that the particular implementations shown and described herein are illustrative of the invention and its best mode and are not intended to otherwise limit the scope of the invention in any way. Indeed, for the sake of brevity, conventional techniques for signal processing, data transmission, signaling, network control, and other functional aspects of the systems (and the individual operating components of the systems) may not be described in detail herein. Furthermore, the connecting lines shown in the figure contained herein are intended to represent exemplary functional relationships and/or physical couplings between the various elements. It should be noted that many alternative or additional functional relationships or physical connections may be present in a practical embodiment.

The processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, the operating system programs and any application programs reside in the permanent memory and portions thereof may be loaded into the system memory during operation. In accordance with the practices of persons skilled in the art of computer programming, the present invention is described below with reference to symbolic representations of operations that may be performed by one or more computing devices associated with system 10. Such operations are sometimes referred to as being computer-executed. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention are essentially the code segments that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

As used herein, a “presentation device” is any device or combination of devices capable of generating a visible display on an associated display element. For example, a presentation device may be a mobile telephone handset, including a “smart phone”, a television set, a set-top box or converter associated with a television monitor, a personal computer, a video game console, a PDA, a remote control device, a home appliance, or the like. Presentation devices are preferably configured in conventional ways known to those skilled in the art. In addition, presentation devices may be suitably configured to function in accordance with certain aspects of the present invention, as described in more detail herein. For the sake of clarity and brevity, conventional and well-known aspects of such presentation devices are not described in detail herein.

According to general principles of the present application, a text secretary interacts the SMS program module. This is to be understood as the text secretary being associated with the SMS program module and functions as a part of the SMS program module. When the text secretary is associated with the SMS program module it creates and connects a library with the SMS program module. The library may include one or more text messages, which may be standard messages, such as: “I am currently in a meeting and will return to you later” or “I am currently not available, I will answer you as soon as possible”. The user may also write personal standard messages and store them in the library. The application according to the invention may cause the telephone to send one or more messages, such as personal standard messages in case the telephone is switched off, out of coverage, in flight mode or Auto reply is on.

The library may also be connected with a calendar program in the smart phone. The calendar program may be a standard calendar program such as “Outlook” or “Google Calendar”. The application will then be capable of extracting data from the calendar program and utilize the data for administrating the SMS program module.

To facilitate the use of the application according to the invention, the text secretary is accessible in the SMS program module. The access may be a button or icon that appears on the screen of the smart phone when the user opens the SMS program module on the phone. When the user touches the button or icon access is provided to the text secretary and library. The text secretary is also optionally accessible from the calendar of the phone. This access may be a corresponding button or icon.

According to principles of the present invention, the application will coordinate the SMS program module and the created library with a calendar program stored in the memory of the mobile phone. Every smart phone has a calendar program and the application makes it possible to utilize events marked in the calendar in the SMS program module. Thus, the application may arrange that an event marked in the calendar results in that an SMS is automatically send from the smart phone to one or more selected addresses. The text secretary will allow the user easy to set up such feature.

An application according to principles of the present invention also coordinates time and date with the SMS program module. Time and date are normally updated frequently on a smart phone and the application ensures that the SMS program module is kept updated with information about time and date.

As mentioned, the application generates and sends an SMS in response to an event. The event may be an event marked in the calendar or a particular date or time. The application may, e.g., cause that a SMS is send to specified receivers once every week or once every month or year. The event may also be a SMS received from a specific sender in which case the application may cause the SMS program module to send a response. The function corresponds to or is an Auto reply function.

According to an embodiment the SMS that is send in response to an event is generated from the library. The SMS may, thus, be an SMS which is already written and stored in the library. The SMS may be reused in case the same event appears several times.

Consequently, the application provides the option that, if an event is marked in the calendar of the smart phone, such as a person's birthday, a SMS reading e.g. “happy birthday” is send to the person. Moreover, if a meeting is marked in the calendar and someone sends a SMS to smart phone, the SMS program module will automatically send a response SMS, such as “I am currently in a meeting and will return to you later”.

The invention also relates to a method for establishing communication between a SMS program module and a calendar program in a telephone, which method comprises the steps of:
installing an application in the telephone;
allowing the application to create a text secretary;
allowing the application to create a library; and
connecting the library with the SMS program module and the calendar program.

According to the method, the text secretary creates a library which connects the SMS program module and at least one calendar program in the telephone. In this manner it is possible to exchange data between the calendar program and the SMS program module. Thus, an event marked in the calendar may cause the SMS program module to send a SMS to a selected telephone number.

The send SMS may be a standard message which can be re-used and, consequently, the method comprises the further step of storing messages in the library. The messages may be standard messages or personalized messages written by the user.

As mentioned the method also comprises the step of sending a message stored in the library in response to an event. The massage may be an Auto reply and the application is adapted for sending Auto reply if the SMS program module receives a SMS.

According to the method the auto reply is send if the telephone is switch off, in flight mode or if the Auto reply is switched on. Thus, a person trying to get in touch with user of telephone will receive a message informing that the user is not available. The message may provide information why the user is not available and when the user will be available.

According to the method, an interface can be created in the SMS menu and a corresponding access in the calendar, such as a logo or button, which can be touched to enter the text secretary and administer the Auto reply and the additional features in the application.

The application according to the invention may be adapted for use in almost every type of smart phones, such as smart phones using the operating systems Android, Symbian OS, iOS, or Windows.

Consequently, the present invention provides an application that delivers an Auto reply function for the SMS program module in a telephone, which Auto reply function can send response messages in case the telephone is switched off or in flight mode or if the user is not available.

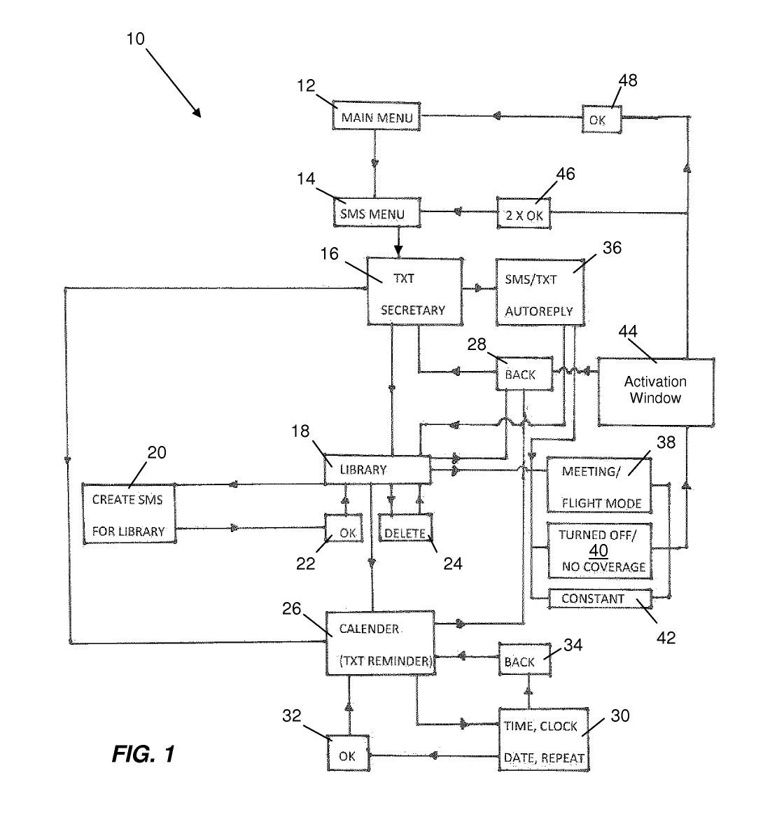

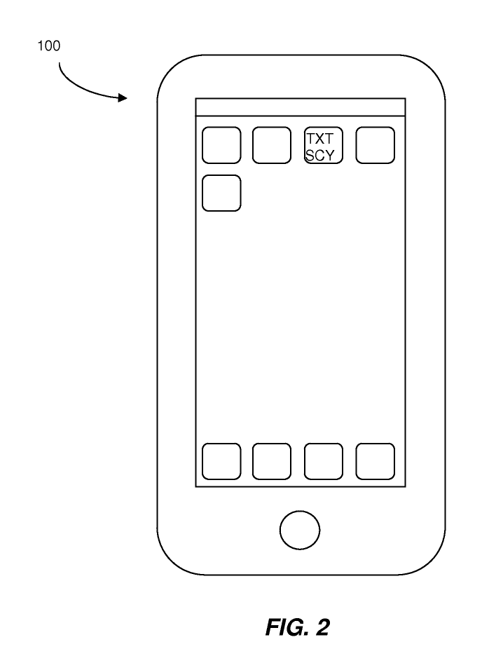

As seen in FIG. 1, a text secretary and a library are created and connect the SMS program module with the calendar in the mobile telephone. Consequently, it is possible for the SMS program module to send a SMS relating to an event marked in the calendar, e.g., a birthday or a wedding day. The SMS may be stored in the library and re-used. With specific reference to the drawing figure, logic 10 embodying principles of the present invention begins at a main display or menu 12 of the telephone handset, e.g., mobile telephone or “smart phone” 100 (see FIG. 2), and optionally presents as an option to proceed to a texting menu 14, e.g., an SMS menu or a menu for a proprietary SMS-like system, e.g., the iMessage system often present on handsets and tablet computers made by Apple Corp. From this option, or even directly from the main menu 12, the user can select the Text Secretary application 16, at which there are several options.

The user can select to proceed to a library of pre-existing text messages, which are stored in a database or library 18; the library data can be resident in memory on the device itself, or can be remotely stored and accessed via the device. When in the library 18, the user can select to create and input a (new) text message, which is then optionally saved in the library 20 for later use (including sending to one or more selected recipients, modification, deletion 24, copying, and the like), and returning 22 to the library 18. Advantageously, from within the library 18, the user can select one or more text strings in the library and enter into a calendar module 26; the calendar module can be such an application which is typically found on commercially available mobile handsets and tablet computers, or can be one specifically associated with the logic 10 described herein. The calendar/calendar interface 26 includes logic which permits the user to enter at least the time, date, and repeat/recurrence data 30 for the sending to one or more recipients of the text strings selected from the library 18; the user can accept that input, 32, or go back to the calendar interface, 34. Further optionally, the calendar 26 can be accessed directly from the text secretary interface 16. From the library 18, the user can return to the text secretary 16, as at 28.

From the text secretary 16, the logic allows the user to define an autoreply text string 36 to be sent, in a manner somewhat similar to autoreply features as are commonly commercially available in email applications. The user can select from the library 18 a pre-existing text string for the autoreply, or can enter a text string directly. Further optionally, the autoreply logic permits the user to select: a meeting/flight mode 38, in which the selected text string is sent out in reply to any incoming text when the computing device is set to a meeting/flight mode; a constant 42 mode, in which the selected text string is sent out in reply to any incoming text; or a turned off/no coverage 40 mode, in which the selected text string is sent out in reply to any incoming text when the computing device is not on any network (the text string and associated send parameters are, in this mode, uploaded to another proxy computing device that can send this text string on behalf of the computing device on which logic 10 is executed). The activation window is also a confirmation window, at which the user can confirm the text message and mode (e.g., Auto Reply, Flight Mode, etc.).

After selecting the particular autoreply mode, the user is presented with an activation window 44, at which the user can confirm the specific mode that has been selected, and then either return 48 to the main menu 12 the SMS main menu 14, as at 46, or back to the text secretary 16, as at 28. In further embodiments, the text secretary integrates with the mobile device's SMS function and calendar function, and can sync with the calendar/withdraw information from the calendar regarding dates and events. Furthermore, it can gather a contact's phone numbers, etc., from the contact database.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. An application for storage in a memory of a mobile computing device, the mobile computing device including an SMS program module, the application comprising: text secretary logic in the SMS program module, the text secretary logic being configured to create a library connected with the SMS program module, and optionally create a calendar application, which library comprises at least one text message.

2. An application according to claim 1, further comprising:
logic which permits access to the text secretary from the SMS program module.

3. An application according to claim 1, further comprising:
logic configured to coordinate the SMS program module and the library with a calendar program when stored in the memory of the mobile computing device.

4. An application according to claim 1, further comprising:
logic configured to coordinate time and date with the SMS program module.

5. An application according to claim 1, further comprising:
logic configured to generate and send a text message in response to an event, or when the computing device is switched off, in a flight mode, or in reply to any incoming text.

6. An application according to claim 1, further comprising:
logic configured to generate a text message from the library or from the calendar.

7. An application according to claim 5, wherein the event is an event marked in the calendar.

8. An application according to claim 1, wherein the mobile computing device is selected from the group consisting of a mobile handset and a tablet computer.

9. A mobile computing device comprising a memory and the application according to claim 1 stored in the memory.

10. A method for establishing communication between a text program module, a calendar program, and a contact database in a mobile computing device, comprising:
installing an application in the mobile computing device;
creating a text secretary with the application;
creating a library with the application; and
connecting the library and the text secretary with the SMS program module, the calendar program, and the contact database.

11. A method according to claim 10, further comprising
storing messages in the library.

12. A method according to claim 11, further comprising:
sending a message stored in the library in response to an event.

13. A method according to claim 10, further comprising:
automatically sending a reply SMS message when the SMS program module receives a SMS message.

14. A method according to claim 13, wherein automatically sending a reply SMS message comprises sending when the telephone is off, in flight mode, or Auto reply is set on in said application.
